(19) United States
(12) Patent Application Publication
(10) Pub. No.: US 2012/0254199 A1
(43) Pub. Date: Oct. 4, 2012

(54) MERGE OPTIMIZATION SYSTEM

(76) Inventors: Harumi Kuno, Cupertino, CA (US); Goetz Graefe, Madison, WI (US)

(21) Appl. No.: 13/077,460

(22) Filed: Mar. 31, 2011

(51) Int. Cl. G06F 17/30

(52) U.S. Cl. 707/752; 707/E17.009

(57) ABSTRACT

A merge optimization system to optimize a run merge process for runs including keys from a data source. The system may include a run generation module to generate a run of the keys in a predetermined order. The system may further include a key characterization module to characterize a distribution of the keys across the run at run generation time, and a run merge module executed by a computer system to selectively associate the runs based on the characterization.

### BACKGROUND

Data processing algorithms may include a full or partial sort of one or more input data sources. Examples of data sort types may include internal and external sorts. An internal sort may include any data sorting process that takes place within the main memory of a computing device (e.g. RAM). This may occur when the data to be sorted is small enough to be held in the main memory. An external sort may be utilized when the data being sorted does not fit into the main memory of the computing device and instead may reside in the external memory, such as a hard drive. External sorting may use a run generation and merge strategy. In the run generation phase, chunks of data small enough to fit in the main memory may be read, sorted, and written out to a temporary file, known as a run. In the merge phase, the runs may be merged to produce a sorted output. Depending on factors such as the amount of memory allocated to merging, the number of external runs, and the algorithm being employed (e.g. some algorithms may interleave merge steps with run generation), multiple merge steps may be performed to obtain a final sorted output.

Merge optimization techniques may be used to increase the merge process efficiency. For example, merge process efficiency may be increased by reducing the number of merge steps. Merge process efficiency may also be increased by reducing the number of run contents moved. Merge optimization techniques may thus employ different strategies to increase the merge process efficiency. A high merge process efficiency for data processing is desirable, for example, for reducing the time it takes for query responses and other applications that use sorted data.

### BRIEF DESCRIPTION OF DRAWINGS

The embodiments are described in detail in the following description with reference to the following figures.

FIG. 1 illustrates a merge optimization system, according to an embodiment;

FIG. 2 illustrates a method for merge optimization, according to an embodiment; and

FIG. 3 illustrates a computer system that may be used for the method and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

### 1. Overview

Data processing algorithms may include, for example, internal and external sorts of one or more input data sources. A data source may include data for creating a run. A run may be a temporary file including keys in a predetermined sorted order. A key may be an element or a value in a run. For the internal sort, the data sorting process may take place within the main memory of a computing device (e.g. RAM). Alternatively, the external sort may be utilized when the data being sorted does not fit into the main memory of the computing device and instead resides in the external memory, such as a hard drive. External sorting may use a run generation and merge strategy where chunks of data small enough to fit in the main memory may be read, sorted, and written out to a run, and runs may be merged to produce a sorted output. In the external sort, methods for increasing the efficiency of the merging process may include reducing the number of merge steps and/or the number of keys moved. Knowledge about the distribution of keys within various runs may be used to optimize the merging process. If knowledge about the distribution of keys (e.g. run elements or contents) is acquired a priori and out-of-band, these steps of obtaining key distribution knowledge can reduce merge efficiency. For example, for a priori acquisition of knowledge about the distribution of keys, the merge process may commence after the knowledge is obtained. For out-of-band acquisition of knowledge about the distribution of keys, additional system resources may be used for the knowledge acquisition.

A merge optimization system is provided for ascertaining the knowledge about the key distribution at runtime. The system may thus acquire and store information pertaining to the distribution of keys in external runs during run generation, as opposed to a priori and out-of-band acquisition. In one example, no a priori knowledge about the key distribution of the original data sources is used by the system. In another example, no restrictions are placed on the system as to which keys can be assigned to which runs. Further, information about run keys may be arbitrarily compressed. This allows for accommodation of the space and time allocated for merge planning.

In an embodiment, the merge optimization system may use a histogram and/or a bitmap index to characterize how various ranges of keys are distributed across particular runs. A histogram may be a statistical representation of data distribution. A bitmap index may be a compact method of expressing data using a small number of bits, e.g. 0's or 1's. In an example, histograms may be created at run generation time. The creation of histograms during run generation may facilitate run processing and merge efficiency by, for example, eliminating the need to ascertain information on runs that are already created, which may require additional processing. For example, as each run may be sorted (e.g. using replacement selection), a histogram generation module of a key characterization module may create a histogram of the keys of the run in a pass. A replacement selection sort may be used to gather the initial runs for external sorting algorithms. Replacement selection may be used to build on a run by selecting the smallest key in memory that can still build on the run. A new run may be started when all of the keys in memory are smaller than the last key output to the current run. The histograms may include buckets that represent keys within a same range. A umber of the buckets in each histogram may be adjusted according to constraints. Based on the space allocated to merge planning, the key distributions for each run may be stored in separate histograms. The number of histograms maintained may be based on the permitted space. The statistics for each run may be merged into the histogram that most reflects its own key distribution. If a single histogram represents the distribution of keys for multiple runs, then a bitmap index generation module of the key characterization module may create a bitmap index indicating contribution of a run to a histogram's buckets. The histogram and bitmap index may be used during merge planning to prioritize which runs, or sub-ranges of keys from runs, to merge first.

The merge optimization system may thus acquire and store information pertaining to the distribution of keys in external runs during run generation, as opposed to a priori and out-of-band acquisition. The merge optimization system may forego the need for a priori knowledge about the key distribution of the original data sources. Further, the merge optimization system does not include restrictions as to which keys can be assigned to which runs.

### 2. System

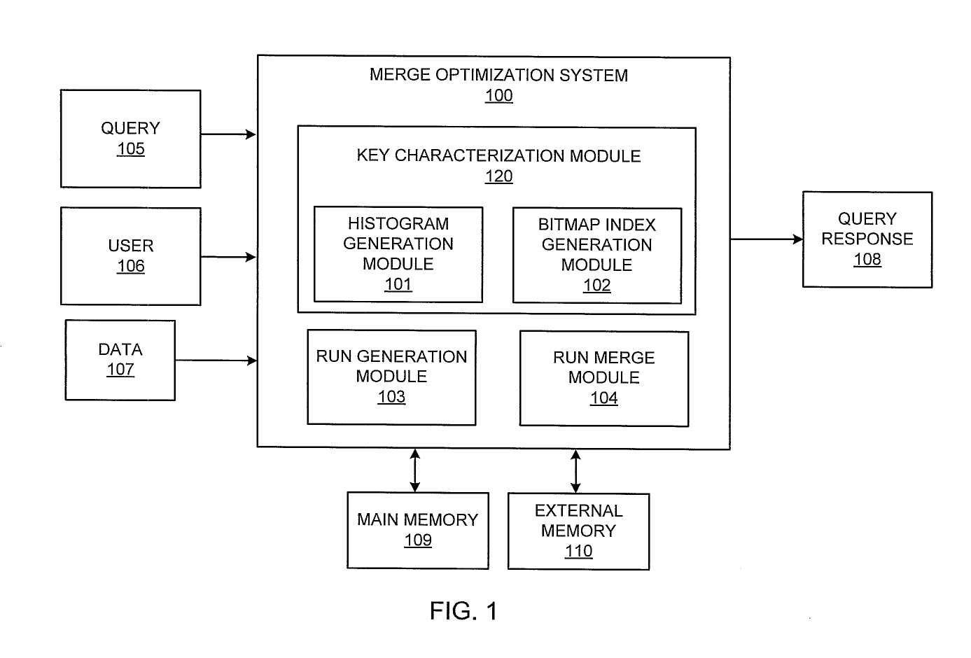

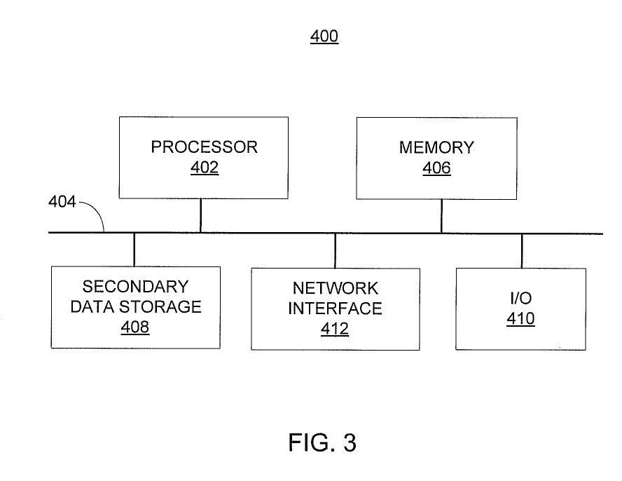

FIG. 1 illustrates a merge optimization system 100, according to an embodiment. The system 100 may include a key characterization module 120 including a histogram generation module 101 and a bitmap index generation module 102 for respectively generating histograms and bitmap indexes for characterizing how various ranges of keys may be distributed across runs. The modules and other components of the system 100 may include machine readable instructions, hardware or a combination of machine readable instructions and hardware. A run generation module 103 and a run merge module 104 may be respectively provided for generating and merging runs as described herein. The results of a query 105 by a user 106 pertaining to data 107 may be generated at query output 108. The system 100 may include a man memory 109 (e.g. RAM), and an external memory 110 (e.g. hard drive) for storing and processing information utilized by the system 100. The external memory 110 may also provide for data storage, and include a database or other type of data management system. Alternatively, the system 100 may utilize resources of a computer system 400 as discussed below with reference to FIG. 3.

Referring to FIG. 1, the histogram generation module 101 may generate a histogram at run generation time. For example, as each run is sorted (e.g. using replacement selection), the module 101 may create a histogram of the keys of the run in a pass. The creation of histograms during run generation may facilitate run processing and merge efficiency by, for example, eliminating the need for ascertaining information on runs that are already created, which may utilize additional processing. The histograms may also include information about the provenance of the keys in each run with regard to the original data source. This information may be used for optimizing run generation. For example, an embodiment of the system 100 may include maintaining the place of each item in an original data file (e.g. for the data 107), and storing two synopses for each run. One synopsis may include a histogram showing subranges of keys (bins) and the number of keys that fall into each subrange (bin). The second synopsis may reflect the order of the keys in the run, compared to their positions in the original data file. For example, the second synopsis may indicate if the original data file were strictly increasing, strictly decreasing, uniformly randomly distributed, or some measure of sortedness (e.g. k-sortedness). Alternatively, the second synopsis may indicate the average distance between keys in the run, compared to keys in the original data file. The histograms may also include buckets, as described herein, that have the same height or same width.

Each run may include a subset of data that is in sorted order. The subset of data may or may not reflect the order of the data 107. When merging runs, the number of runs may be greater than the space available in memory for merging the runs. For example, assuming the main memory 109 can hold a predetermined maximum number of keys, in an example, a replacement selection sort may be used to gather the initial runs for external sorting algorithms. Replacement selection may be used to build on a run by selecting the smallest key in memory that may still build on the run. A new run may be started when all of the keys in memory are smaller than the last key output to the current run.

For example, for replacement selection, if the query 105 by the user 106 pertains to keys 1, 2, 8, 15, 3, 7, 9, 4 and 6 from data 107, in order to create an ascending run using the main memory 109 capable of holding, for example, three keys, the system 100 may first read in keys 1, 2 and 8. For the 1^{st} run, since the query 105 pertains to additional data, the run generation module 101 may write out key 1 to a run, and read in key 15. Then the module 101 may write out key 2 to the run, and read in key 3. Then the module 101 may write out key 3 to the run, and read in key 7. Then the module 101 may write out key 7 to the run, and read in key 9. Then the module 101 may write out key 8 to the run, and read in key 4. However, since the key 4 is lower than the last key already written to the current run (e.g. 4<8), the key 4 may not be written out. Then the module 101 may write out key 9 to the run, and read in key 6. However, since key 6 is lower than the last key already written to the current run (e.g. 6<9), it may not be written out. Lastly, the module 101 may read in and then write out key 15. The 2^{nd} run may contain keys 4 and 6. Assuming for example there are additional runs (e.g., ten runs) and additional data (not shown above), the three memory slots may be used to merge the multiple runs. In this manner, the first three runs may include: 1^{st} run—1, 2, 3, 7, 8, 9, 15; 2^{nd} run—4, 6, 8, 10, 12, 14; 3^{rd} run—5, 7, 9, 11 (it should be noted that the 1^{st} to 3^{rd} runs include additional data not listed above; the additional data is provided for facilitating the merge process description). Assuming the ten runs as indicated above, runs four-ten may include additional sorted keys. Since the ten runs may not fit into the three slot memory, a method of merging the ten runs may be to pick three of the runs, merge them, then pick three additional runs, merge them, and when the total number of merged runs is less than or equal to the number of memory slots, merge the merged runs to obtain a single merged run. In the foregoing example, since the size of 1^{st} run is greater than the three-slot memory, in order to merge the 1^{st} to 3^{rd} runs, the first key of each run may be read into the three-slot memory. For example, the first run may include keys 1, 4 and 5 from the 1^{st} to 3^{rd} runs, respectively, read into the memory. For a 1^{st} result run, the key 1 may be written. Thereafter, the key 2 may be read from the 1^{st} run, and written to the 1^{st} result run. Then the key 3 may be read from the 1^{st} run, and written to the 1^{st} result run. Then the key 7 may be read from the 1^{st} run, and the key 4 may be written to the 1^{st} result run. Subsequent keys for the 1^{st} result run may be used from the 2^{nd} and 3^{rd} runs. In this manner, the 1^{st} result run may include the keys of the 1^{st} to 3^{rd} runs (e.g. (1, 2, 3, 4, 5, 6, 7, 7, 8, 8, 9, 9, 10, 11, 12, 14, 15)).

Based on the foregoing example, it can be seen that the number of runs that can be merged at once may be based on the size of the memory. For example, for the foregoing example of a n-slotted memory, n+1 runs may require multiple merge steps. In order to optimize merging of runs, one method may be to first merge the runs that have the least amount of overlap in key ranges. Further, for some runs, merging may be bypassed if the contents of the runs are not relevant to the query 105 or if the ranges of keys contained within the runs do not overlap. For example, if a run has a highest key of 15 and another run has a lowest key of 25, instead of merging these two runs, the runs may be concatenated to each other. Alternatively, the merging may be provided for certain key ranges in runs. For example, if two runs have very few keys greater than 25, then the range of keys greater than 25 may be merged from both runs.

Run merge module 104 of merge optimization system 100 may thus associate runs based on the distribution information described herein. As described herein, the association of runs may include selective merging and/or concatenating of runs, or merging and/or concatenating of ranges and/or subranges of runs and/or sub-runs. For each run, the system 100 may capture the range of keys contained in each run, and the relative density of keys within subranges. For example, histogram generation module 101 may generate a histogram that describes how keys are distributed in a given run. For example, a histogram may indicate that some runs have 25 keys between keys 1 and 15, and 0 keys between keys 16 and 75, and 1000 keys between keys 76 and 100. Thus module 101 may generate a histogram indicating the density of keys within subranges (e.g. 1-15, 16-75 and 76-100). Module 101 may also ascertain the range of the subranges (e.g. minimum/maximum ranges). Other parameters such as standard deviation, mean, mode and other statistical metrics or statistical moments about the distribution may also be ascertained by the module 101.

In order to capture the foregoing information about a run distribution during run generation, run generation module 103 and run merge module 104 may ascertain the association between the order of keys in the original data file and the sorted keys output during run generation. For the foregoing example, for the 1^{st} run of 1, 2, 3, 7, 8, 9, 15, modules 103 and 104 may ascertain the sorted keys based on the premises that subsequent keys are in increasing order compared to keys that have been ascertained. Thus based on replacement selection, modules 103 and 104 may select the lowest key in memory that is higher than or equal to the last key written to a run. This may provide for keys to enter a run in a sorted order. For example, if a run includes a key 15, any key with a value less than 15 may be saved for a new run.

In order to determine whether keys in the original data source are naturally correlated to an ascending or descending order, meta information captured about the distribution of keys within runs may include statistical information about the correlation of the data within a given run to their original positions in the original data source. This may provide for longer runs and sorting in a fewer number of runs.

For a histogram generated by histogram generation module 101, the histogram may include subranges and the system 100 may maintain a record of the number of items in each subrange. In order to determine a size of a subrange within a run, the module 101 may select a boundary so that all keys within a subrange have approximately the same number of occurrences. For example, if a run has fifteen occurrences of the keys two, three and four, and two occurrences of other keys in a run, the keys two, three and four may be placed in a separate subrange. Thus a histogram may include three histogram buckets: one bucket for the keys two, three and four containing forty-five items, a second bucket containing the two occurrences of other keys, and a third bucket for all remaining keys. System 100 may also provide for the number of buckets in each histogram to be adjusted according to space constraints. This may allow for comparison with histograms for other runs. For example, the amount of detail in a histogram may limit the amount of histogram information that is ascertained at a given time. Other forms of histograms may also be supported, including for example, equi-width, equi-depth, V-optimal, etc.

Sorting data may also facilitate histogram bucket planning during run generation. For example, if a run includes keys in a range of 1-20, but does not include keys 8 and 9, during run generation, a histogram bucket may be made of keys 1-20, despite the outliers 8 and 9. Histogram bucket planning during run generation may thus limit the amount of space used for storing information. Histogram bucket planning may also include merging of buckets during run generation. As the number of distinct keys in a run becomes larger, buckets may be selectively merged, for example, by keys that are close to each other. The variance of instances per key that appear in each bucket may also be reduced. For example, in order to create a new bucket, buckets may be merged based on similarity (e.g. ranges that are close to each other, or instances that are close to each other). For buckets containing certain subranges, a merged bucket may contain the merged subranges. For a merge based on data size, a histogram may include buckets including information about a subrange within each bucket. The information for each run may thus be used to determine an order for merging runs (e.g. which runs to merge).

As described herein, the histogram generation module 101 may generate histograms as runs are being processed. If two runs have similarly shaped distributions (e.g. data is uniformly random and thus the runs have a flat histogram), one histogram may be used to represent multiple runs. This may reduce the data used to represent multiple runs. For runs having a similar shape but different start and end points, for example, a first run may be designated such that it looks similar to a first histogram with start and end points at A and B, respectively, and a second run may be designated such that is looks similar to a second histogram with start and end points C and D. In this manner, similar histograms may be identified and then the runs may be appropriately matched to the histograms. Histogram shapes may also be matched. For example, for a histogram showing an increasing order, one set of data may be similarly used to describe multiple runs.

Based on the foregoing, information about how keys are distributed across runs may be used during merge planning to merge sparsely populated key ranges first. The population of key ranges may be based on a ratio of keys (number of actual keys) compared to the length of a key range. Thus sub-runs may be merged based on the population of key ranges. For example, sub-runs that have a limited number of keys in the key ranges may be merged. Thus for two runs that are to be merged, sparsely populated sub-runs within each run (e.g. most sparsely populated from run 1, and most sparsely populated from run 2), may be merged first.

Information about how keys are distributed across runs may be used during merge planning to assign hash functions and fast normalized keys according to the density of keys within various subranges (e.g. use more bits for denser populations of keys). For example, in order to alter the runs and generate a hash table, or to use a hash table to perform an operation on a merge, knowledge of the key density within the subranges may facilitate selection of a hash function. This is because given a key, a hash function may produce a code that represents that key. If a subrange includes a limited number of keys, a simpler hash function may be utilized (e.g. a hash function that uses fewer bits to compare).

Information about how keys are distributed across runs may be used with adaptive merging, which may use density information to guide partition merges (e.g. proactively merge, for example, by rounding, sparsely populated sub-runs that may contain “popular” ranges of keys). In this regard, runs may not need to be merged at once to limit system resource utilization. If a user queries data in certain key ranges (e.g. provide all phone numbers for a state), based on the query, the system 100 may ascertain just the data used to answer the query from the run, merge the appropriate data and write the data to a new run. In this manner, for a new run query that is in the data range of the original run query, no further merging may be performed. Thus the density information may be used to determine the scope of a user's query.

Information about how keys are distributed across runs may be used during merge planning to avoid comparisons and concatenate (possibly virtually) disjoint runs or sub-runs. As described above, if a histogram includes empty sections (e.g. no instances of keys between keys from 20 to 75), for another run with several keys between 20 to 75, instead of merging these two runs, a single run may be created by concatenating the two runs.

Information about how keys are distributed across runs may also be used during merge planning to avoid processing runs that don't contain keys in a range of interest. For example, as discussed herein for adaptive merging, when answering a query about a state (e.g. provide all phone numbers for a state), if a run has no keys about the state in question, that run may be bypassed.

Based on the foregoing, the merge optimization system described herein may thus provide for capture and storage of information related to distribution of sort keys in runs when performing an external sort. The system may thus acquire and store information pertaining to the distribution of keys in external runs during run generation, as opposed to a priori and out-of-band acquisition.

### 3. Method

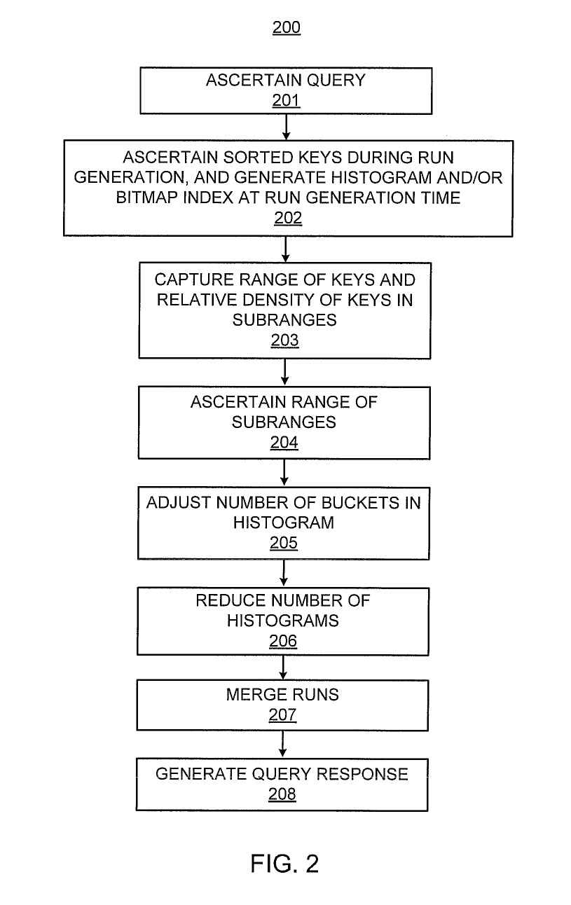

FIG. 2 illustrates a method 200 for merge optimization, according to an embodiment. The method 200 is described with respect to the merge optimization system 100 shown in FIG. 1 by way of example and not limitation. The method 200 may be performed by other systems.

At block 201, the system 100 may receive the query 105 and ascertain the requirements of the query. For example, the user 106 may present the query 105 pertaining to the data 107 to the system 100.

At block 202, based on the query 105, in order to capture information about a run distribution during run generation, run generation module 103 may commence the run generation process by ascertaining the association between the order of keys in the original data file and the sorted keys output during run generation. Run merge module 104 may also ascertain the association between the order of keys in the original data file and the sorted keys output during run generation as described herein for the run merge process. Module 103 may ascertain the sorted keys based on the premises that subsequent keys are in increasing order compared to keys that have been ascertained. Thus based on replacement selection, module 103 may select the lowest key in memory that is higher than or equal to the last key written to a run. This may provide for keys to enter a run in a sorted order.

Also at block 202, the histogram generation module 101 may generate a histogram at run generation time. For example, as each run is sorted (e.g. using replacement selection), the module 101 may create a histogram of the keys of the run in a pass. The creation of histograms during run generation may facilitate run processing and merge efficiency by, for example, eliminating the need for ascertaining information on runs that are already created, which may utilize additional processing. The histograms may also include information about the provenance of the keys in each run with regard to the original data source. This information may be used for optimizing run generation. For example, as described above, an embodiment of the system 100 may include maintaining the place of each item in an original data file (e.g. for the data 107), and storing two synopses for each run. One synopsis may include a histogram showing subranges of keys (bins) and the number of keys that fall into each subrange (bin). The second synopsis may reflect the order of the keys in the run, compared to their positions in the original data file. For example, the second synopsis may indicate if the original data file were strictly increasing, strictly decreasing, uniformly randomly distributed, or some measure of sortedness (e.g. k-sortedness). Alternatively, the second synopsis may indicate the average distance between keys in the run, compared to keys in the original data file. The histograms may also include buckets, as described herein, that have the same height or same width. Each run may include a subset of data that is in sorted order. The subset of data may or may not reflect the order of the data 107. When merging runs, the number of runs may be greater than the space available in memory for merging the runs. For example, assuming the main memory 109 can hold a predetermined maximum number of keys, in an example, the replacement selection sort may be used to gather the initial runs for external sorting algorithms. Replacement selection may be used to build on a run by selecting the smallest key in memory that may still build on the run. A new run may be started when all of the keys in memory are smaller than the last key output to the current run.

Also at block 202, the bitmap index generation module 102 may generate a bitmap index to characterize how various ranges of keys are distributed across particular runs. As discussed herein, the merge optimization system 100 may use a histogram and/or a bitmap index to characterize how various ranges of keys are distributed across particular runs.

At block 203, for each run, the system 100 may capture the range of keys contained in each run, and the relative density of keys within subranges. For example, the histogram generation module 101 may generate a histogram that describes how keys are distributed in a given run. The module 101 may generate a histogram indicating the density of keys within subranges.

At block 204, the module 101 may also ascertain the range of the subranges (e.g. minimum/maximum ranges). Other parameters such as standard deviation, mean, mode and other statistical metrics about the distribution may also be ascertained by the module 101. In order to determine the minimum and maximum keys, for a variable register, if a key exceeds a current variable, the key may be written to a register. The variable register may be set for determining minimum and maximum keys, which are kept track of as additional data is placed in a run file. Another type of metadata besides histograms and bitmap indexes may thus include aggregate information related to a number of keys, minimum and maximum, sum etc. For a histogram generated by the histogram generation module 101, the histogram may include subranges and the system 100 may maintain a record of the number of items in each subrange. In order to determine a size of a subrange within a run, the module 101 may select a boundary so that all keys within a subrange have approximately the same number of occurrences.

At block 205, the system 100 may also provide for the number of buckets in each histogram to be adjusted according to space constraints. This may allow for comparison with histograms for other runs. For example, the amount of detail in a histogram may limit the amount of histogram information that is ascertained at a given time. Sorting data may also facilitate histogram bucket planning during run generation. Histogram bucket planning during run generation may thus limit the amount of space used for storing information. Histogram bucket planning may also include merging of buckets during run generation. As the number of distinct keys in a run becomes larger, buckets may be selectively merged, for example, by keys that are close to each other. The variance of instances per key that appear in each bucket may also be reduced. For example, in order to create a new bucket, buckets may be merged based on similarity (e.g. ranges that are close to each other, or instances that are close to each other). For buckets containing certain subranges, a merged bucket may contain the merged subranges. For a merge based on data size, a histogram may include buckets including information about a subrange within each bucket. The information for each run may thus be used to determine an order for merging runs (e.g. which runs to merge).

At block 206, the number of histograms may be reduced based, for example, on the run shape. If two runs have similarly shaped distributions (e.g. data is uniformly random and thus the runs have a flat histogram), one histogram may be used to represent multiple runs. This may reduce the data used to represent multiple runs. For runs having a similar shape but different start and end points, for example, a first run may be designated such that it looks similar to a first histogram with start and end points at A and B, respectively, and a second run may be designated such that is looks similar to a second histogram with start and end points C and D. In this manner, similar histograms may be identified and then the runs may be appropriately matched to the histograms. Histogram shapes may also be matched. For example, for a histogram showing an increasing order, one set of data may be similarly used to describe multiple runs.

At block 207, run merge module 104 may associate the runs as described herein. As described herein, the association of runs may include selective merging and/or concatenating of runs, or merging and/or concatenating of ranges and/or subranges of runs and/or sub-runs. The number of runs that can be merged at once may be based on the size of the memory. For example, for a n-slotted memory, n+1 runs may require multiple merge steps. In order to optimize merging of runs, one method may be to first merge the runs that have the least amount of overlap in key ranges. Further, for some runs, merging may be bypassed if the contents of the runs are not relevant to the query 105 or if the ranges of keys contained within the runs do not overlap. Alternatively, the merging may be provided for certain key ranges in runs. Run merge module 104 of merge optimization system 100 may thus merge runs based on the distribution information described herein.

At block 208, the system 100 may generate a query response providing the sorted data to the user 106 at the query output 108.

### 4. Computer Readable Medium

FIG. 3 shows a computer system 400 that may be used with the embodiments described herein. The computer system 400 represents a generic platform that includes components that may be in a server or another computer system. The computer system 400 may be used as a platform for the system 100. The computer system 400 may execute, by a processor or other hardware processing circuit, the methods, functions and other processes described herein. These methods, functions and other processes may be embodied as machine readable instructions stored on computer readable medium, which may be non-transitory, such as hardware storage devices (e.g. RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums.

The computer system 400 may include an I/O device 410, such as a keyboard, a mouse, a display, etc. The computer system 400 may include a network interface 412 for connecting to a network. Other known electronic components may be added or substituted in the computer system 400.

While the embodiments have been described with reference to examples, various modifications to the described embodiments may be made without departing from the scope of the claimed embodiments.

What is claimed is:

1. A merge optimization system to optimize a run merge process for runs including keys from a data source, the system comprising:
a run generation module to generate a run of the keys in a predetermined order;
a key characterization module to characterize a distribution of the keys across the run at run generation time; and
a run merge module, executed by a computer system, to selectively associate the runs based on the characterization.

2. The system of claim 1, wherein the run includes the keys in a predetermined sorted order.

3. The system of claim 1, wherein the key characterization module includes a histogram generation module to generate a histogram characterizing the distribution of the keys across the run at the run generation time.

4. The system of claim 3, wherein the histogram includes subranges of the keys and a number of the keys in each subrange.

5. The system of claim 3, wherein the histogram is associated with a plurality of the runs based on a shape of the runs.

6. The system of claim 1, wherein the key characterization module includes an order of the keys in the run, compared to key positions in the data source.

7. The system of claim 1, wherein the key characterization module includes a bitmap index generation module to generate a bitmap index characterizing the distribution of the keys across the run at the run generation time.

8. The system of claim 1, wherein the run merge module selectively merges the runs based on the characterization.

9. The system of claim 1, wherein the run merge module selectively concatenates the runs based on the characterization.

10. The system of claim 1, wherein the run merge module selectively associates at least one of ranges and subranges of at least one of the runs and sub-runs based on the characterization.

11. The system of claim 1, wherein the run generation module generates the run based on a replacement selection sort.

12. A method for merge optimization for a run merge process for runs including keys from a data source, the method comprising:
generating a run of the keys in a predetermined order;
characterizing a distribution of the keys across the run at run generation time; and
selectively associating, by a computer, the runs based on the characterization.

13. The method of claim 12, wherein characterizing the distribution further comprising generating a histogram characterizing the distribution of the keys across the run at the run generation time.

14. The method of claim 13, wherein the histogram includes subranges of the keys and a number of the keys in each subrange.

15. The method of claim 12, wherein characterizing the distribution further comprising including an order of the keys in the run and comparing the order to key positions in the data source.

16. The method of claim 12, wherein characterizing the distribution further comprising generating a bitmap index characterizing the distribution of the keys across the run at the run generation time.

17. The method of claim 12, wherein selectively associating further comprising selectively merging the runs based on the characterization.

18. The method of claim 12, wherein selectively associating further comprising selectively concatenating the runs based on the characterization.

19. The method of claim 12, wherein selectively associating further comprising selectively associating at least one of ranges and subranges of at least one of the runs and sub-runs based on the characterization.

20. A non-transitory computer readable medium storing machine readable instructions, that when executed by a computer system, perform a method for merge optimization for a run merge process for runs including keys from a data source, the method comprising:
generating a run of the keys in a predetermined order;
characterizing a distribution of the keys across the run at run generation time; and
selectively associating, by a computer, the runs based on the characterization.
